(19) United States
(12) Patent Application Publication
(10) Pub. No.: US 2016/0202764 A1
(43) Pub. Date: Jul. 14, 2016

(54) DRIVE CONTROL APPARATUS, ELECTRONIC DEVICE AND DRIVE CONTROLLING METHOD

(71) Applicant: FUJITSU LIMITED, Kawasaki-shi (JP)

(72) Inventors: Yuichi KAMATA, Isehara (JP); Yasuhiro ENDO, Ebina (JP); Akinori MIYAMOTO, Sagamihara (JP)

(73) Assignee: FUJITSU LIMITED, Kawasaki-shi (JP)

(21) Appl. No.: 15/078,640

(22) Filed: Mar. 23, 2016

Related U.S. Application Data
(63) Continuation of application No. PCT/JP2013/076079, filed on Sep. 26, 2013.

(51) Int. Cl. G06F 3/01; G06F 3/0484; G06F 3/041; G06F 3/0488

(52) U.S. Cl. CPC G06F 3/016; G06F 3/04883; G06F 3/04845; G06F 3/04847; G06F 3/0414

(57) ABSTRACT

A drive control apparatus that drives a vibrator of an electronic device including a display, a top panel disposed on a display surface side of the display and having a manipulation input surface, a position detector detecting a position of a manipulation input performed on the manipulation input surface and the vibrator generating a vibration in the manipulation input surface, including, a drive controller being configured to drive the vibrator by using a drive signal causing the vibrator to generate a natural vibration in an ultrasound-frequency-band in the manipulation input surface, the drive controller being configured to drive the vibrator so as to switch the natural vibration between a strong level and a weak level in accordance with a relationship between a position of a designated GUI input part displayed on the display and a position of a manipulation input performed onto the manipulation input surface.

### CROSS-REFERENCE TO RELATED APPLICATION

This application is a continuation application of International Application PCT/JP2013/076079 filed on Sep. 26, 2013 and designated the U.S., the entire contents of which are incorporated herein by reference.

### FIELD

The embodiment discussed herein is related to a drive control apparatus, an electronic device and a drive controlling method.

### BACKGROUND

There has been a tactile sensation producing apparatus which includes a display, a contact detector that detects a contact state of user's manipulate operation to the display and a haptic vibration generating part which generates haptic vibration that gives a designated sensation to the user's body-part contacting the display (for example, see Patent Document 1).

The tactile sensation producing apparatus further includes a vibration waveform data generating means which generates a waveform data based on a detected result of the contact detector. The waveform data is used for generating the haptic vibration. The tactile sensation producing apparatus further includes an ultrasound modulating means which performs a modulating process on the waveform data by utilizing an ultrasound as a carrier wave and outputs an ultrasound signal generated by the modulating process to the haptic vibration generating means as a signal used for generating the haptic vibration.

The ultrasound modulating means performs either a frequency modulation or a phase modulation. The ultrasound modulating means further performs an amplitude modulation.

There has been a tactile sensation producing apparatus that includes a display panel, a touch panel disposed on a surface of the display panel and configured to detect a position coordinate at which an object touches, and a first vibration actuator configured to vibrate the touch panel in a first direction parallel to the surface, wherein the first direction is a horizontal direction (see patent document 2, for example).

The tactile sensation producing apparatus further includes a second vibration actuator configured to vibrate the touch panel in a second direction parallel to the surface and perpendicular to the first direction. The tactile sensation producing apparatus further includes a controller which drives the first vibration actuator and/or the second vibration actuator when the object is moving in an area in which a designated image information is displayed on the display panel while the object is touching the touch panel, and stops the first vibration actuator and the second vibration actuator when the object is stopped or the object does not touch the touch panel.

However, an ultrasound frequency used in the conventional tactile sensation producing apparatus may be any frequency as long as the frequency is higher than that of an audio frequency (about 20 kHz). No specific setting is made for the ultrasound frequency. Accordingly, the tactile sensation producing apparatus cannot provide a fine or crisp tactile sensation to the user.

Since the conventional tactile sensation producing apparatus vibrate the touch panel in the direction parallel to horizontal direction, the apparatus cannot provide a fine or crisp tactile sensation to the user.

### RELATED-ART DOCUMENTS

### Patent Documents

### [Patent Document 1] Japanese Laid-open Patent Publication No. 2010-231609

### [Patent Document 2] Japanese Laid-open Patent Publication No. 2003-337649

### SUMMARY

According to an aspect of the present application, there is provided a drive control apparatus that drives a first vibrating element of an electronic device including a display part, a top panel disposed on a display surface side of the display part and having a manipulation input surface, a position detector detecting a position of a manipulation input performed on the manipulation input surface and the first vibrating element generating a vibration in the manipulation input surface, including, a first drive controller being configured to drive the first vibrating element by using a drive signal causing the first vibrating element to generate a natural vibration in an ultrasound-frequency-band in the manipulation input surface, the first drive controller being configured to drive the first vibrating element so as to switch the natural vibration between a strong level and a weak level in accordance with a relationship between a position of a designated GUI input part displayed on the display part and a position of a manipulation input performed onto the manipulation input surface.

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 is a diagram illustrating an electronic device according to a first embodiment in perspective view;

FIG. 2 is a diagram illustrating the electronic device of the first embodiment in plan view;

FIG. 3 is a diagram illustrating a cross-sectional view of the electronic device taken along a line A-A of FIG. 2;

FIG. 4 is a diagram illustrating crests and troughs of standing wave formed in parallel with a short side of a top panel included in standing waves generated in the top panel by the natural vibration at the ultrasound-frequency-band;

FIG. 5 is a diagram illustrating cases where a kinetic friction force applied to the fingertip varies when the natural vibration at the ultrasound-frequency-band is generated in the top panel of the electronic device;

FIG. 6 is a diagram illustrating a configuration of the electronic device according to the embodiment;

FIG. 7 is a diagram illustrating control data in which data representing operation modes, data representing incoming calls, and data representing target GUI input parts are associated with each other;

FIG. 8 is a diagram illustrating a flowchart executed by a drive controller and an LRA driver of a drive control apparatus according to the embodiment;

FIG. 9 is a diagram illustrating an example of an operating states of the electronic device according to the embodiment;

FIG. 10 is a diagram illustrating an example of an operating states of the electronic device according to the embodiment;

FIG. 11 is a diagram illustrating an example of an operating states of the electronic device according to the embodiment;

FIG. 12 is a diagram illustrating an example of an operating states of the electronic device according to the embodiment;

FIG. 13 is a diagram illustrating driving waveforms used for driving the vibrating element and an LRA of the electronic device; and

FIG. 14 is a diagram illustrating driving waveforms used for driving the vibrating element of the electronic device.

### DESCRIPTION OP EMBODIMENT

Hereinafter, an embodiment to which a drive control apparatus, an electronic device and a drive controlling method of the present invention are applied will be described.

### Embodiment

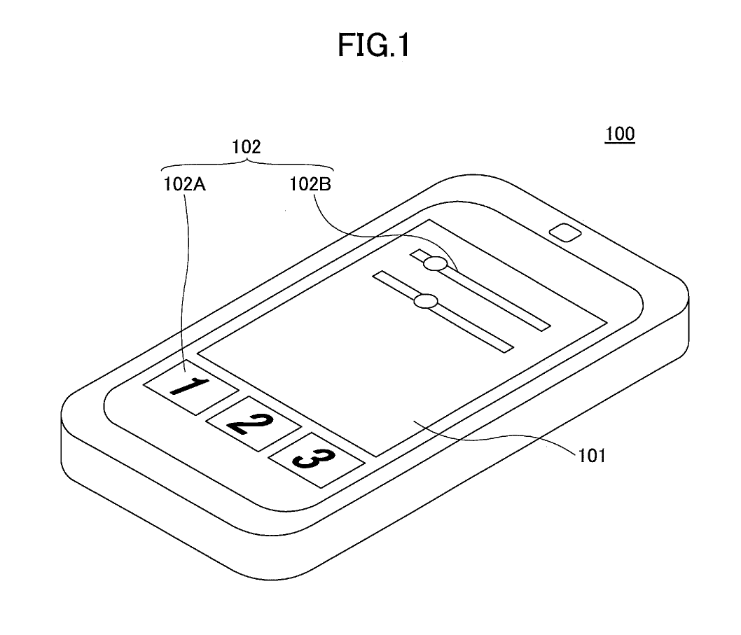

FIG. 1 is a diagram illustrating an electronic device 100 according to the embodiment in perspective view.

The electronic device 100 is a smart phone or a tablet computer that includes a touch panel as a manipulation input part, for example. The electronic device 100 may be any device as long as the device includes a touch panel as a manipulation input part. Accordingly, the electronic device 100 may be a device such as a handy type information terminal device, an Automatic Teller Machine (ATM) placed at a specific location or the like, for example.

In a manipulation input part 101 of the electronic device 100, a display panel is disposed under a touch panel, and a button 102A, a slider 102B or the like (hereinafter referred to as Graphic User Interface (GUI) input part(s) 102) are displayed on the display panel.

A user of the electronic device 100 touches the manipulation input part 101 in order to manipulate (operate) the GUI input part 102 with a fingertip under normal conditions.

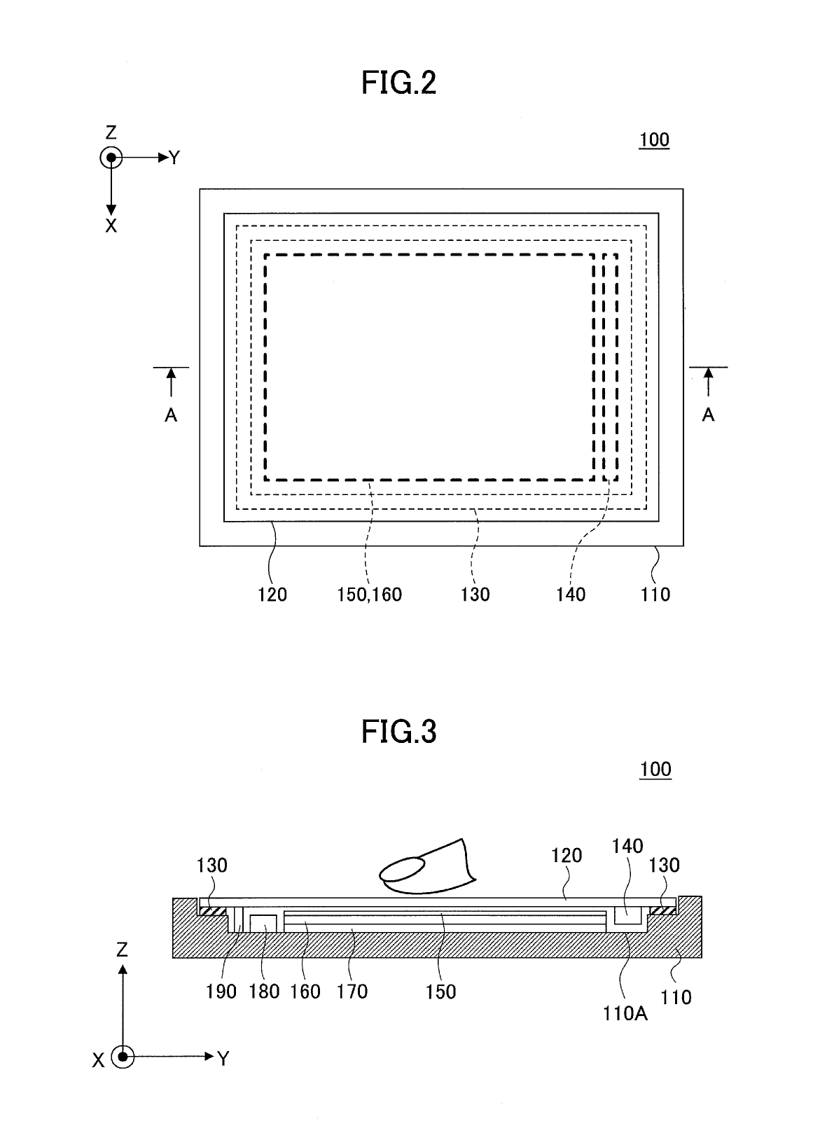

Hereinafter, a detailed configuration of the electronic device 100 will be described with reference to FIG. 2.

FIG. 2 is a diagram illustrating the electronic device 100 of the embodiment in plan view. FIG. 3 is a diagram illustrating a cross-sectional view of the electronic device 100 taken along a line A-A of FIG. 2. An XYZ coordinate system as an orthogonal coordinate system is defined in FIGS. 2 and 3.

The electronic device 100 includes a housing 110, a top panel 120, a double-faced adhesive tape 130, a vibrating element 140, a touch panel 150, a display panel 160, a substrate 170, a Linear Resonant Actuator (LRA) 180 and a pressure sensor 190.

The housing 110 is made of a plastic, for example. As illustrated in FIG. 3, the substrate 170, the display panel 160 and the touch panel 150 are contained in a concave portion 110A of the housing 110, and a top panel 120 is adhered onto the housing 110 by the double-faced adhesive tape 130.

The top panel 120 is a plate-shaped member having a rectangular shape in plan view and is made of a transparent glass or a reinforced plastic such as polycarbonate. A surface of the top panel 120 which is located on a positive side in Z axis direction is one example of a manipulation input surface into which the user of the electronic device 100 performs a manipulation input.

The vibrating element 140 is bonded on a surface of the top panel 120 which is located on a negative side in Z axis direction, and the top panel 120 is adhered to the housing 110 by the double-faced adhesive tape 130. Herein, the double-faced adhesive tape 130 is not necessarily a rectangular-ring-shaped member in plan view as illustrated in FIG. 3, as long as the double-faced adhesive tape 130 can adhere four corners of the top panel 120 to the housing 110.

The touch panel 150 is disposed on the negative side in Z axis direction of the top panel 120. The top panel 120 is provided for the sake of protecting the surface of the touch panel 150. Another panel, protection film or the like may be provided onto the surface of the top panel 120.

In a state where the vibrating element 140 is bonded onto the surface of the top panel 120 located on the negative side in Z axis direction, the top panel 120 vibrates if the vibrating element 140 is being driven. In the embodiment, a standing wave is generated in the top panel 120 by causing the top panel 120 to vibrate at a natural vibration frequency (natural resonance frequency or eigenfrequency) of the top panel 120. Since the vibrating element 140 is bonded to the top panel 120, it is preferable to determine the natural vibration frequency in consideration of a weight of the vibrating element 140 or the like, in a practical manner.

The vibrating element 140 is bonded on the surface of the top panel 120 which is located on the negative side in Z axis direction at a location along the short side extending in X axis direction at a positive side in Y axis direction. The vibrating element 140 may be any element as long as it can generate vibration at an ultrasound-frequency-band. A piezoelectric element such as a piezo element is used as the vibrating element 140, for example. The vibrating element 140 is an example of the first vibrating element.

The vibrating element 140 is driven in accordance with a drive signal output from the drive controller which will be described later. An amplitude (intensity) and a frequency of the vibration output from the vibrating element 140 is set (determined) by the drive signal. An on/off action of the vibrating element 140 is controlled in accordance with the drive signal.

The ultrasound-frequency-band is a frequency band which is higher than or equal to about 20 kHz, for example. According to the electronic device 100 of the embodiment, the frequency at which the vibrating element 140 vibrates is equal to a number of vibrations per unit time (frequency) of the top panel 120. Accordingly, the vibrating element 140 is driven in accordance with the drive signal so that the vibrating element 140 vibrates at a number of natural vibrations per unit time (natural vibration frequency) of the top panel 120.

The touch panel 150 is disposed on upper side (positive side in Z axis direction) of the display panel 160 and is disposed on lower side (negative side in Z axis direction) of the top panel 120. The touch panel 150 is one example of a coordinate detector which detects a position at which the user of the electronic device 100 touches the top panel 120. Hereinafter, the position is referred to as a position of the manipulation input.

The display panel 160 disposed under the touch panel 150 displays various GUI buttons or the like. Hereinafter, the various GUI buttons or the like are referred to as a GUI input part. The user of the electronic device 100 ordinarily touches the top panel 120 with a fingertip in order to manipulate (operate) the GUI input part.

The touch panel 150 is any coordinate detector as long as it can detect the position of the manipulation input onto the top panel 120 performed by the user. The touch panel 150 may be a capacitance type coordinate detector or a resistance film type coordinate detector, for example. Hereinafter, the embodiment in which the touch panel 150 is the capacitance type coordinate detector will be described. In a case where the touch panel 150 is the capacitance type, the touch panel 150 can detect the manipulation input performed onto the top panel 120 even if there is a clearance gap between the touch panel 150 and the top panel 120.

Although the top panel 120 is disposed on the manipulation input surface side of the touch panel 150 in the present embodiment, the top panel 120 may be integrated with the touch panel 150. In this case, the surface of the touch panel 150 is equal to the surface of the top panel 120 as illustrated in FIGS. 2 and 3, and the surface of the touch panel 150 becomes the manipulation input surface. Otherwise, the top panel 120 as illustrated in FIGS. 2 and 3 may be omitted. In this case, the surface of the touch panel 150 constitutes the manipulation input surface. In this case, the vibrating element 140 vibrates the manipulation input surface at a natural vibration frequency of a member having the manipulation input surface.

In a case where the touch panel 150 is the capacitance type, the touch panel 150 may be disposed on the top panel 120. In this case, the surface of the touch panel 150 constitutes the manipulation input surface. In a case where the touch panel 150 is the capacitance type, the top panel 120 as illustrated in FIGS. 2 and 3 may be omitted. In this case, the surface of the touch panel 150 constitutes the manipulation input surface. In this case, the vibrating element 140 vibrates the manipulation input surface at a natural vibration frequency of a member having the manipulation input surface.

The display panel 160 is a display part which displays a picture image. The display panel 160 may be a liquid crystal display panel, an organic Electroluminescence (EL) panel or the like, for example. The display panel 160 is disposed in the concave portion 110A of the housing 110 and is disposed on (the positive side in Z axis direction of) the substrate 170.

The display panel 160 is driven by a driver Integrated Circuit (IC) and displays the GUI input part, the picture image, characters, symbols, graphics or the like in accordance with an operating state of the electronic device 100.

The substrate 170 is disposed in the concave portion 110A of the housing 110. The display panel 160 and the touch panel 150 are disposed on the substrate 170. The display panel 160 and the touch panel 150 are fixed to the substrate 170 and the housing 110 by a holder or the like (not shown).

On the substrate 170, a drive control apparatus which will be described hereinafter and circuits or the like that are necessary for driving the electronic device 100 are mounted.

The LRA 180 is attached to the concave portion 110A of the housing 110. According to the present embodiment, the LRA 180 is driven in response to a drive signal at a frequency in an audible range. The LRA 180 may be an LRA including a voice coil or an LRA including a piezoelectric element. The LRA 180 is an example of the second vibrating element.

The LRA 180 is driven by the drive signal at the audible range frequency. The LRA 180 is a vibrating device which generates vibration at an audible range. A vibration amount of the vibration varies in accordance with an amplitude of the drive signal.

The pressure sensor 190 is attached in the concave portion 110A of the housing 110 and detects a pressure applied to the top panel 120 by the manipulation input of the user. The pressure sensor 190 may be any type of sensor as long as the pressure sensor 190 can detect the pressure applied on the top panel 120 by the manipulation input of the user. The pressure sensor 190 may be a diaphragm pressure gauge including a Micro Electro Mechanical Systems (MEMS) and the like, for example.

The pressure sensor 190 detects a pressing force allied to the GUI buttons and the like when the user of the electronic device 100 presses a designated GUI button or the like in order to determine an certain input.

In the electronic device 100 having the configuration as described above, when the user touches the top panel 120 with the fingertip and a movement of the fingertip is detected, the drive controller mounted on the substrate 170 drives the vibrating element 140 so that the top panel 120 vibrates at a frequency in the ultrasound-frequency-band. The frequency in the ultrasound-frequency-band is a resonance frequency of a resonance system including the top panel 120 and the vibrating element 140. A standing wave is generated in the top panel 120 at the frequency.

The electronic device 100 generates the standing wave in the ultrasound-frequency-band in the top panel 120 and provides a tactile sensation (haptic sensation) to the user through the top panel 120.

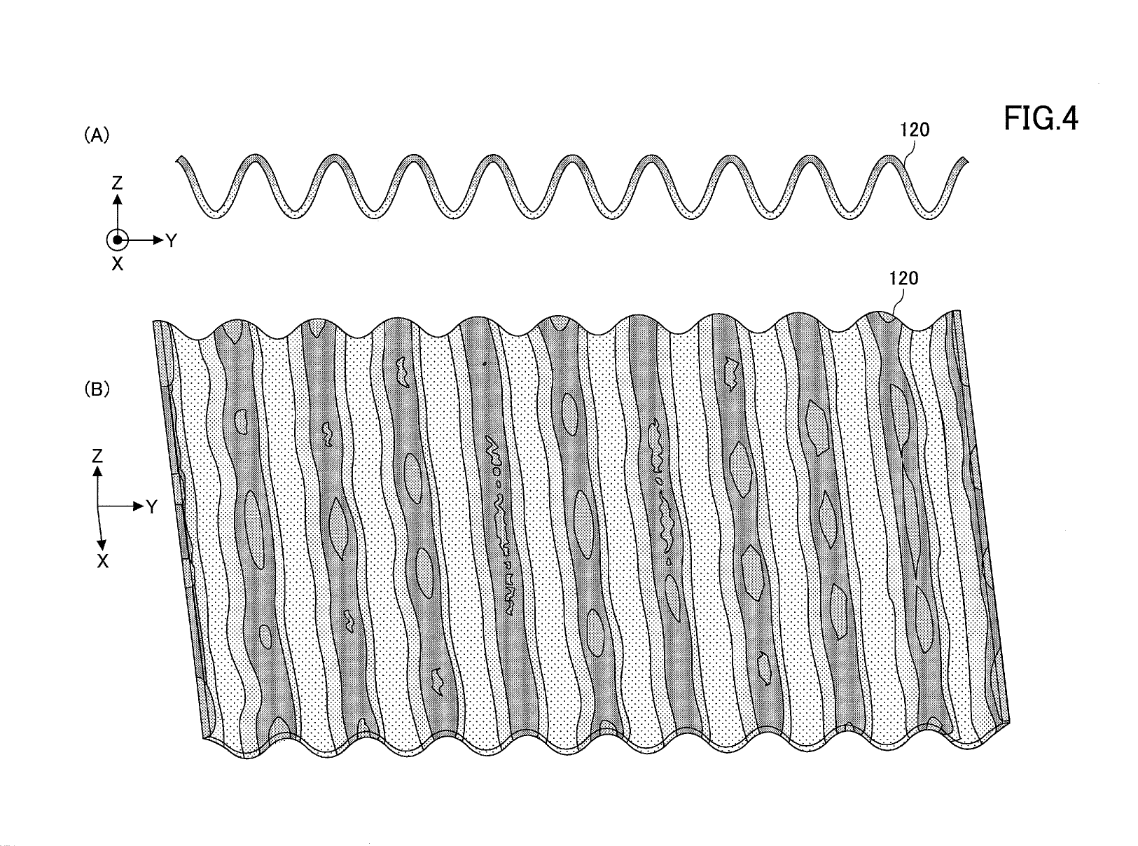

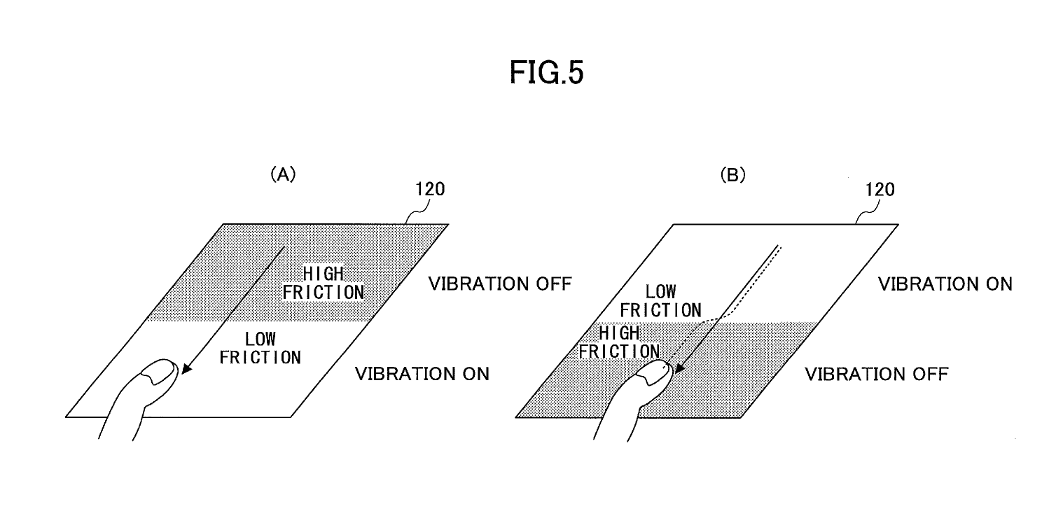

Next, the standing wave generated in the top panel 120 is described with reference to FIG. 4.

FIG. 4 is a diagram illustrating crests and troughs of the standing wave formed in parallel with the short side of the top panel 120 included in the standing waves generated in the top panel 120 by the natural vibration at the ultrasound-frequency-band. A part (A) of FIG. 4 illustrates a side view, and a part (B) of FIG. 4 illustrates a perspective view. In parts (A) and (B) of FIG. 4, a XYZ coordinate system similar to that described in FIGS. 2 and 3 is defined. In parts (A) and (B) of FIG. 4, the amplitude of the standing wave is overdrawn in an easy-to-understand manner. The vibrating element 140 is omitted in parts (A) and (B) of FIG. 4.

The natural vibration frequency (the resonance frequency) f of the top panel 120 is represented by formulas (1) and (2) where E is the Young's modulus of the top panel 120, ρ is the density of the top panel 120, δ is the Poisson's ratio of the top panel 120, l is the long side dimension of the top panel 120, t is the thickness of the top panel 120, and k is a periodic number of the standing wave along the direction of the long side of the top panel 120. Since the standing wave has the same waveforms in every half cycle, the periodic number k takes values at 0.5 intervals. The periodic number k takes 0.5, 1, 1.5, 2 . . . .

$$\begin{matrix}f = \frac{π {k}^{2} t}{{l}^{2}} \sqrt{\frac{E}{3 ρ ( 1 - {δ}^{2} )}} & ( 1 ) \\ f = α {k}^{2} & ( 2 )\end{matrix}$$

The coefficient α included in formula (2) corresponds to coefficients other than k² included in formula (1).

A waveform of the standing wave as illustrated in parts (A) and (B) of FIG. 4 is obtained in a case where the periodic number k is 10, for example. In a case where a sheet of Gorilla (registered trademark) glass of which the length 1 of the long side is 140 mm, the length of the short side is 80 mm, and the thickness t is 0.7 mm is used as the top panel 120, for example, the natural vibration number f is 33.5 kHz, if the periodic number k is 10. In this case, a frequency of the drive signal is 33.5 kHz.

The top panel 120 is a planar member. If the vibrating element 140 (see FIGS. 2 and 3) is driven and the natural vibration at the ultrasound-frequency-band is generated in the top panel 120, the top panel 120 is bent as illustrated in parts (A) and (B) of FIG. 4. As a result, the standing wave is generated in the top panel 120.

In the present embodiment, the single vibrating element 140 is bonded on the surface of the top panel 120 which is located on the negative side in Z axis direction at the location along the short side extending in X axis direction at the positive side in Y axis direction. The electronic device 100 may include two vibrating elements 140. In a case where the electronic device 100 includes two vibrating elements 140, another vibrating element 140 may be bonded on the surface of the top panel 120 which is located on the negative side in Z axis direction at a location along the short side extending in X axis direction at a negative side in Y axis direction. In this case, the two vibrating elements 140 are disposed at locations that are axially symmetric with respect to a center line of the top panel 120 parallel to the two short sides of the top panel 120.

In a case where the electronic device 100 includes two vibrating elements 140, the two vibrating elements 140 are driven in the same phase, if the periodic number k is an integer number. If the periodic number k is a decimal fraction, the two vibrating elements 140 are driven in opposite phases.

Next, the natural vibration at ultrasound-frequency-band generated in the top panel 120 of the electronic device 100 is described with reference to FIG. 5.

FIG. 5 is a diagram illustrating cases where a kinetic friction force applied to the fingertip varies when the natural vibration at the ultrasound-frequency-band is generated in the top panel 120 of the electronic device 100. In FIG. 5, the manipulation input is performed with the fingertip. In parts (A) and (B) of FIG. 5, the user touches the top panel 120 with the fingertip and performs the manipulation input by tracing the top panel 120 with the fingertip in a direction from a far side to a near side with respect to the user. An on/off state of the vibration is switched by controlling an on/off state of the vibrating element 140 (see FIGS. 2 and 3).

In parts (A) and (B) of FIG. 5, areas in which the fingertip touches while the vibration is turned off are indicated in grey in the direction from the far side to the near side. Areas in which the fingertip touches while the vibration is turned on are indicated in white in the direction from the far side to the near side.

As illustrated in FIG. 4, the natural vibration at the ultrasound-frequency-band occurs on an entire surface of the top panel 120. Parts (A) and (B) of FIG. 5 illustrate operation patterns in which the on/off state of the natural vibration is switched while the fingertip of the user is tracing the top panel 120 in the direction from the far side to the near side.

Accordingly, in parts (A) and (B) of FIG. 5, the areas in which the fingertip touches while the vibration is turned off are indicated in grey in the direction from the far side to the near side. The areas in which the fingertip touches while the vibration is turned on are indicated in white in the direction from the far side to the near side.

In the operation pattern as illustrated in part (A) of FIG. 5, the vibration is turned off when the fingertip of the user is located on the far side of the top panel 120, and the vibration is turned on in the process of tracing the top panel 120 with the fingertip toward the near side.

On the contrary, in the operation pattern as illustrated in part (B) of FIG. 5, the vibration is turned on when the fingertip of the user is located on the far side of the top panel 120, and the vibration is turned off in the process of tracing the top panel 120 with the fingertip toward the near side.

In a state where the natural vibration at the ultrasound-frequency-band is generated in the top panel 120, a layer of air intervenes between the surface of the top panel 120 and the fingertip. The layer of air is provided by a squeeze film effect. As a result, a kinetic friction coefficient on the surface of the top panel 120 is decreased when the user traces the surface with the fingertip.

Accordingly, in the grey area located on the far side of the top panel 120 as illustrated in part (A) of FIG. 5, the kinetic friction force applied to the fingertip becomes larger. In the white area located on the near side of the top panel 120, the kinetic friction force applied to the fingertip becomes smaller.

Therefore, the user who is performing the manipulation input to the top panel 120 in a manner as illustrated in part (A) of FIG. 5 senses a reduction of the kinetic friction force applied to the fingertip when the vibration is turned on. As a result, the user senses a slippery or smooth touch (texture) with the fingertip. In this case, the user senses as if a concave portion is provided on the surface of the top panel 120 when the surface of the top panel 120 becomes slippery and the kinetic friction force becomes lower.

On the contrary, in the white area located on the far side of the top panel 120 as illustrated in part (B) of FIG. 5, the kinetic friction force applied to the fingertip becomes smaller. In the grey area located on the near side of the top panel 120, the kinetic friction force applied to the fingertip becomes higher.

Therefore, the user who is performing the manipulation input in the top panel 120 in a manner as illustrated in part (B) of FIG. 5 senses an increase of the kinetic friction force applied to the fingertip when the vibration is turned off. As a result, the user senses a grippy or scratchy touch (texture) with the fingertip. In this case, the user senses as if a convex portion is provided on the surface of the top panel 120 when the surface of the top panel 120 becomes grippy and the kinetic friction force becomes higher.

Accordingly, the user can sense a concavity or convexity with the fingertip in cases as illustrated in parts (A) and (B) of FIG. 5. For example, “The Printed-matter Typecasting Method for Haptic Feel Design and Sticky-band Illusion” (The collection of papers of the 11th SICE system integration division annual conference (SI2010, Sendai)_174-177, 2010-December) discloses that a human can sense a concavity or a convexity. “Fishbone Tactile Illusion” (Collection of papers of the 10th Congress of The Virtual Reality Society of Japan (September, 2005)) discloses that a human can sense a concavity or a convexity as well.

Although a variation of the kinetic friction force when the vibration is switched on or off is described above, a variation of the kinetic friction force similar to those described above is obtained when the amplitude (intensity) of the vibrating element 140 is varied.

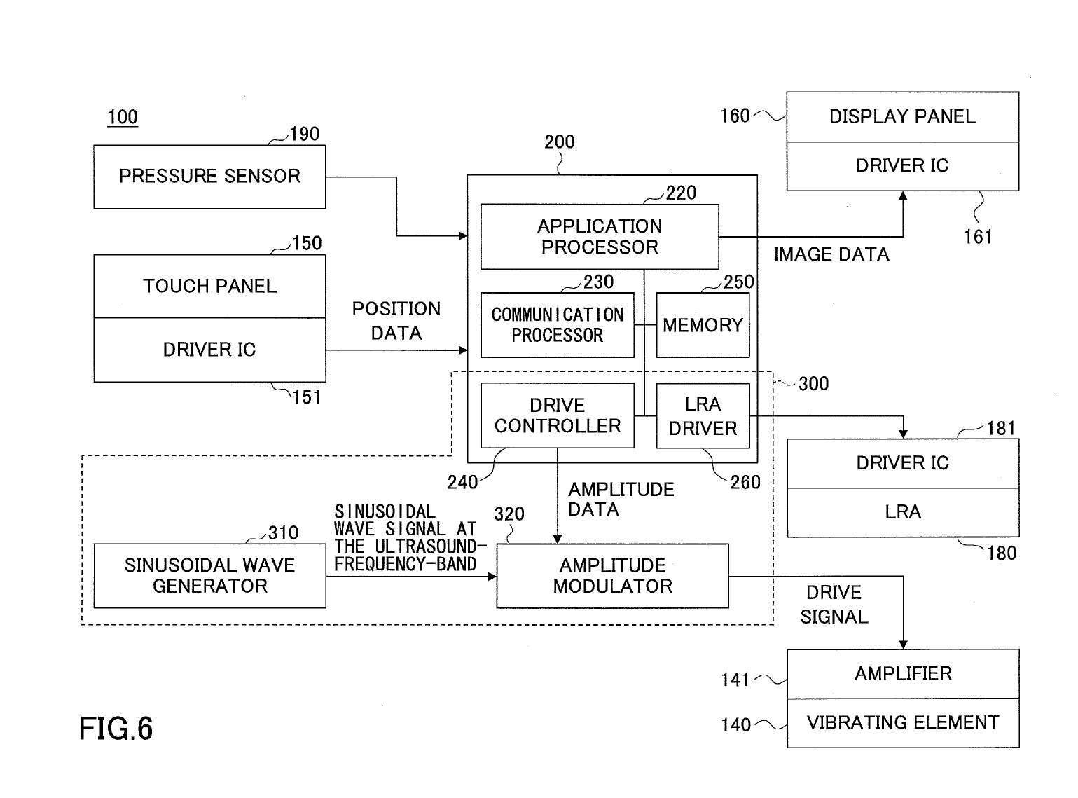

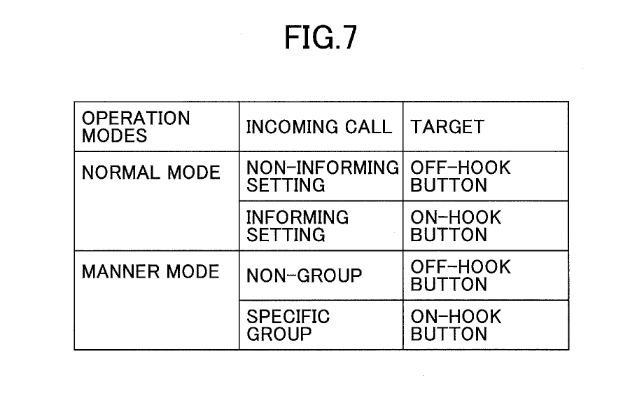

In the following, a configuration of the electronic device 100 according to the embodiment is described with reference to FIG. 6. Hereinafter, driving waveform used for driving the vibrating element 140 of the electronic device 100 will be described with reference to FIG. 7 in addition to FIG. 6.

FIG. 6 is a diagram illustrating the configuration of the electronic device 100 according to the embodiment.

The electronic device 100 includes the vibrating element 140, an amplifier 141, the touch panel 150, a driver Integrated Circuit (IC) 151, the display panel 160, a driver IC 161, an LRA 180, a driver IC 181, a pressure sensor 190, a controller 200, a sinusoidal wave generator 310 and the amplitude modulator 320.

The controller 200 includes an application processor 220, a communication processor 230, a drive controller 240, a memory 250 and an LRA driver 260. The controller 200 is realized by an IC chip, for example.

The drive controlling part 240, the sinusoidal wave generator 310 and the amplitude modulator 320 constitute a drive controlling apparatus 300. Although an embodiment in which the application processor 220, the communication processor 230, the drive controlling part 240 and the memory 260 is included in the single controller 200 is described, the drive controlling part 240 may be disposed outside of the controller 200 and realized by another IC chip or a processor. In this case, data which is necessary for a drive control performed by the drive controller 240 among data stored in the memory 250 may be stored in another memory disposed in the drive controlling apparatus 300.

Similarly, the LRA driver 260 may be provided as another IC chip or processor located outside of the controller 200. In this case, data which is necessary for a drive control performed by the LRA driver 260 among data stored in the memory 250 may be stored in another memory disposed in the drive control apparatus 300.

In FIG. 6, the housing 110, the top panel 120, the double-faced adhesive tape 130 and the substrate 170 (see FIG. 2) are omitted. Herein, the amplifier 141, the driver IC 151, the driver IC 161, the drive controller 240, the memory 250, the LRA driver 260, the sinusoidal wave generator 310 and the amplitude modulator 320 are described.

The amplifier 141 is disposed between the drive control apparatus 300 and the vibrating element 140. The amplifier 141 amplifies the drive signal output from the drive control apparatus 300 and drives the vibrating element 140.

The driver IC 151 is connected to the touch panel 150. The driver IC 151 detects position data representing the position on the touch panel 150 at which the manipulation input is performed and outputs the position data to the controller 200. As a result, the position data is input to the application processor 220 and the drive controller 240. Inputting the position data to the drive controller 240 is equal to inputting the position data to the drive control apparatus 300.

The driver IC 161 is connected to the display panel 160. The driver IC 161 outputs image data input from the drive control apparatus 300 to the display panel 160 and displays a picture image to the display panel 160 based on the image data. Accordingly, the GUI input part, the picture image and the like are displayed on the display panel 160 based on the image data.

The LRA 180 is driven by the LRA driver 260 in response to a drive signal at an audible range frequency. The LRA 180 is driven by the drive signal at the audible range frequency. The LRA 180 is a vibrating device which generates vibration at an audible range. A vibration amount of the vibration varies in accordance with an amplitude of the drive signal.

The driver IC 181 performs digital to analog conversion and amplification. The driver IC 181 converts the drive signal input from the LRA driver 260 into an analog signal, amplifies the amplitude of the converted analog signal and outputs the amplified analog signal to the LRA 180.

The pressure sensor 190 detects a pressing force applied to the GUI buttons and the like when a user of the electronic device 100 presses a designated GUI button or the like in order to determine a certain input. The application processor 220 determines whether the certain input is determined.

The application processor 220 executes various application programs included in the electronic device 100.

The communication processor 230 performs processes that are necessary for communications of 3rd Generation (3G), 4th Generation (4G), Long Term Evolution (LTE), WiFi or the like of the electronic device 100.

The drive controller 240 outputs amplitude data to the amplitude modulator 320 in response to presence or absence of the manipulation input and the travel distance of the position of the manipulation input. The amplitude data represents an amplitude value used for controlling an intensity of the drive signal used for driving the vibrating element 140.

If the user touches the top panel 120 in a designated operation mode, the drive controller 240 switches on and off the vibrating element 140 so as to switch an intensity of a natural vibration generated onto the top panel 120 between a strong level and a weak level in response to a positional relationship between a position of the designated GUI input part displayed on the display panel 160 and a position of the manipulation input performed onto the top panel 120. If the vibration of the top panel 120 is switched on and off, the kinetic friction force applied to the user's fingertip is varied. Accordingly, the user can recognize a travel distance of the manipulation input through the tactile sensation.

When the drive controller 240 switches on and off the vibrating element 140, the user obtains a tactile sensation of a concavity and a convexity through their fingertip. It is possible to provide the tactile sensation of the concavity and the convexity to the user's fingertip by switching on and off the vibrating element 140.

The memory 250 stores control data in which data representing operation modes, data representing incoming calls, and data representing target GUI input parts are associated with each other.

The data representing the operation modes includes data representing operation modes such as a normal mode, manner mode and the like, for example. The manner mode is a mode in which the electronic device 100 informs the user of an incoming call, a reception of mail or the like without ringing an incoming call sound, a mail reception sound or the like. The normal mode is a mode in which the electronic device 100 informs the user of the incoming call, the reception of mail or the like by ringing the incoming call sound, the mail reception sound or the like.

The data representing the incoming call is data which indicates types of an incoming call from people who set a non-informing setting of a phone number, an incoming call from people who set a informing setting of a phone number, an incoming call from people included in a specific group, an incoming call from people who is not included in the specific group or the like.

The data representing the target GUI input part includes a type of a GUI input part and data representing a position of the GUI input part. The target GUI input part is used as a target of the user's fingertip. The drive control apparatus 300 generates the natural vibration in the ultrasound-frequency-band on the top panel 120 in response to the position of the manipulation input for the sake of guiding the user's fingertip to the target. The drive control apparatus 300 generates the natural vibration on the top panel 120 in response to the position of the manipulation input in order to guide the user's fingertip in a display area of the target GUI input part.

The data representing the GUI input parts include data representing an on-hook button and an off-hook button. Further, the data representing the GUI input parts includes data representing a certain button, a certain slider or the like that is used for manipulating various applications. The data representing the position of the GUI input part is data which represents a coordinate of a display area of the GUI input part displayed on the display panel 160. The data representing the position of the GUI input part is data which represents a coordinate of the display area of the GUI input part by a formula such as f1={(x, y)|f1(x, y)}, for example.

The memory 250 stores data and programs that are necessary for the application processor 220 to execute the application program and data and programs that are necessary for the communication processor 230 to perform a communication processing.

The LRA driver 260 drives the LRA 180 in response to the drive signal at the audible range frequency when the position of the user's manipulation input is located in a display area of a designated GUI input part. The LRA driver 260 is one example of a second drive controller. The LRA 180 is driven by the LRA driver 260 in response to the drive signal at the audible range frequency and generates the vibration in the audible range. A vibration amount of the LRA 180 varies in response to the amplitude of the drive signal output from the LRA driver 260.

The sinusoidal wave generator 310 generates sinusoidal waves used for generating the drive signal which causes the top panel 120 to vibrate at the natural vibration number. For example, when causing the top panel 120 to vibrate at a natural vibration frequency f of 33.5 kHz, the frequency of the sinusoidal wave is 33.5 kHz. The sinusoidal wave generator 310 inputs a sinusoidal wave signal at the ultrasound-frequency-band to the amplitude modulator 320.

The amplitude modulator 320 generates the driving signal by modulating an amplitude of the sinusoidal wave input from the sinusoidal wave generator 310 based on the amplitude data input from the drive controller 240. The amplitude modulator 320 modulates only the amplitude of the sinusoidal wave signal at the ultrasound-frequency-band input from the sinusoidal wave generator 310 and does not modulate a frequency and a phase of the sinusoidal wave signal in order to generate the drive signal.

Therefore, the drive signal output from the amplitude modulator 320 is a sinusoidal wave signal at the ultrasound-frequency-band obtained by modulating only the amplitude of the sinusoidal wave signal at the ultrasound-frequency-band output from the sinusoidal wave generator 310. In a case where the amplitude data is zero, the amplitude of the drive signal becomes zero. This is the same as that amplitude modulator 320 does not output the drive signal.

FIG. 7 is a diagram illustrating the control data in which the data representing the operation modes, the data representing the incoming calls, and the data representing the target GUI input parts are associated with each other.

The data representing the operation modes includes the data representing the operation modes such as the normal mode, the manner mode and the like, for example. In FIG. 7, for the sake of illustrating contents of the control data in an easy-to-understand manner, the data representing the operation mode is illustrated as “normal mode” and “manner mode”. However, the control data may include codes representing “normal mode” and “manner mode” in a practical manner.

The manner mode is the mode in which the electronic device 100 informs the user of the incoming call, the reception of mail or the like without ringing the incoming call sound, the mail reception sound or the like, for example. The normal mode is an operation mode which is obtained by cancelling the manner mode, for example. The normal mode is the mode in which the electronic device 100 informs the user of the incoming call, the reception of mail or the like by ringing the incoming call sound, the mail reception sound or the like, for example.

The data representing the incoming call is the data which indicates types of the incoming call from the people who set the non-informing setting of the phone number, the incoming call from the people who set the informing setting of the phone number, the incoming call from the people included in the specific group, the incoming call from the people who are not included in the specific group or the like.

In FIG. 7, for the sake of illustrating contents of the control data in an easy-to-understand manner, the data representing the incoming calls is illustrated as “non-informing”, “informing”, “non-group” and “specific group”. However, the control data may include codes representing “non-informing”, “informing”, “non-group” and “specific group” in a practical manner.

The data representing the target GUI input part includes the type of the GUI input part and the data representing the position of the GUI input part. The data representing the GUI input parts include the data representing the on-hook button and the off-hook button. Further, the data representing the GUI input parts includes the data representing the certain button, the certain slider or the like that is used for manipulating the various applications.

In FIG. 7, for the sake of illustrating contents of the control data in an easy-to-understand manner, the data representing the target GUI input part is illustrated as “off-hook button” and “on-hook button”. However, the control data may include codes representing “off-hook button” and “on-hook button” in a practical manner.

The data representing the position of the GUI input part is the data which represents the coordinate of the display area of the GUI input part displayed on the display panel 160. The data representing the position of the GUI input part is the data which represents the coordinate of the display area of the GUI input part by the formula such as f1={(x, y)|f1(x, y)}, for example. The data representing the position of the GUI input part may be associated with the data representing the corresponding GUI input part.

Since the control data as illustrated in FIG. 7 is one example, the control data may include another data other than the data as illustrated in FIG. 7 as the data representing the operation mode, the data representing the incoming call and the data representing the target GUI input part.

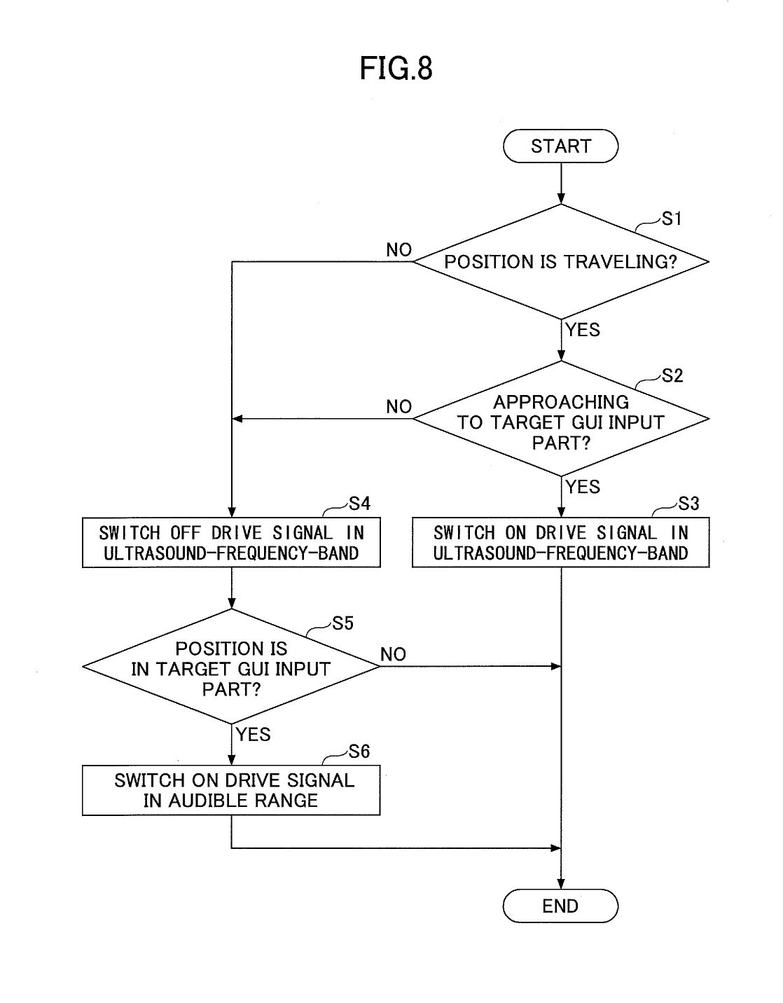

In the following, control processes performed by the drive controller 240 and the LRA driver 260 of the drive control apparatus 300 of the embodiment will be described with reference to a flowchart as illustrated in FIG. 8.

FIG. 8 is a diagram illustrating a flowchart executed by the drive controller 240 and the LRA driver 260 of the drive control apparatus 300 according to the embodiment. The drive controller 240 and the LRA driver 260 executes the control processes as illustrated in FIG. 8 in cooperation with each other in accordance to the type of the operation mode. The drive controller 240 and the LRA driver 260 executes the control processes in a manner as will be described hereinafter based on the control data as illustrated in FIG. 7 in accordance with the types of the operation mode.

The control processes as illustrated in FIG. 8 are repeatedly executed at every control cycle. An operating system (OS) of the electronic device 100 executes drive controls of the electronic device 100 at every designated control cycle, for example.

The drive controller 240 determines whether the position of the manipulation input is traveling (step S1). The drive controller 240 determines whether the position of the manipulation input is traveling based on a change of the position data output from the driver IC 151. More precisely, the drive controller 240 determines whether the position of the manipulation input is traveling by determining whether the position data obtained at step S1 of the previous control cycle and the position data obtained at step S1 of the current control cycle are different with each other.

If the drive controller 240 determines that the position of the manipulation input is traveling (S1:YES), the drive controller 240 determines whether the position of the manipulation input is approaching to the target GUI input part (step S2). The drive controller 240 determines whether the position of the manipulation input is approaching to the target GUI input part based on a positional relationship between the position of the target GUI input part obtained from the control data in accordance with the types of the operation mode and the traveling position of the manipulation input.

If the drive controller 240 determines that the position of the manipulation input is approaching to the target GUI input part (S2: YES), the drive controller 240 switches on the drive signal in order to generate the natural vibration in the ultrasound-frequency-band on top panel 120 (step S3). When the natural vibration in the ultrasound-frequency-band is generated on the top panel 120, the layer of air is generated by the squeeze film effect. Accordingly, the kinetic friction force applied to the user's fingertip is decreased. As a result, the user's fingertip is guided to the target GUI input part.

After switching on the drive signal at step S3 and thereby generating the natural vibration in the ultrasound-frequency-band on the top panel 120, the drive controller 240 finishes the processes (END).

In a case where the drive controller 240 determines that the position of the manipulation input is not traveling (S1:NO) and the drive signal is turned on, the drive controller 240 switches off the drive signal so that the natural vibration in the ultrasound-frequency-band generated on the top panel 120 is switched off (step S4).

The drive controller 240 determines that the position of the manipulation input is not traveling at step S1 in a case where the position of the manipulation input is stopped, for example. In a case where the manipulation input is not performed, the drive controller 240 may determine that the position of the manipulation input is not traveling at step S1 in addition to the case as described above. There may be two cases in that the drive controller 240 determines that the position of the manipulation input is stopped. A first case is that the position of the manipulation input is located in the display area of the target GUI input part. A second case is that the position of the manipulation input is not located in the display area of the target GUI input part.

At step S4, the drive controller 240 keeps the drive signal in an off-state in a case where the drive signal is turned off at the previous control cycle.

In a case where the drive controller 240 determines that the position of the manipulation input is not approaching to the target GUI input part (S2:NO) and the drive signal is turned on, the drive controller 240 switches off the drive signal so that the natural vibration in the ultrasound-frequency-band generated on the top panel 120 is switched off (step S4).

The drive controller 240 determines that the position of the manipulation input is not approaching to the target GUI input part in a case where the position of the manipulation input is traveling in a direction away from the target GUI input part. The case as described above may include a case where the fingertip passes the target GUI input part after the fingertip has reached the target GUI input part and further travels in a direction away from the target GUI input part.

The drive controller 240 determines whether the position of the manipulation input is located in the display area of the target GUI input part (step S5). The drive controller 240 determines whether the position of the manipulation input is located in the display area of the target GUI input part by determining whether the position represented by the position data obtained at the current control cycle, i.e., the current position of the manipulation input, is located in the area of the target GUI input part obtained from the control data in accordance with the types of the operation mode.

If the drive controller 240 determines that the position of the manipulation input is located in the display area of the target GUI input part (S5: YES), the drive controller 240 causes the LRA driver 260 to drive the LRA 180 so as to generate the vibration in the audible range on the top panel 120 (step S6).

In a case where the position of the manipulation input is located in the display area of the target GUI input part, the user's fingertip touches the target GUI input part. For the sake of informing the user that their fingertip approaches the target GUI input part, the vibration in the audible range is generated on the top panel 120.

When the natural vibration in the audible range is generated on the top panel 120, the layer of air of the squeeze film effect is not generated. This is different from the case where the natural vibration in the ultrasound-frequency-band is generated on the top panel 120. Accordingly, the kinetic friction force applied to the user's fingertip is increased compared with the case where the natural vibration in the ultrasound-frequency-band is generated on the top panel 120.

It is possible to inform the user that their fingertip reaches the target GUI input part through the tactile sensation by generating the vibration in the audible range on the top panel 120 when the position of the manipulation input reaches in the display area of the target GUI input part.

Upon finishing step S6, the drive controller 240 finishes the drive control (END).

If the drive controller 240 determines that the position of the manipulation input is not located in the display area of the target GUI input part (S5: NO), the drive controller 240 finishes the drive control (END). This is for the sake of repeating the processes from step S1 in a case where the position of the manipulation input is not located in the display area of the target GUI input part.

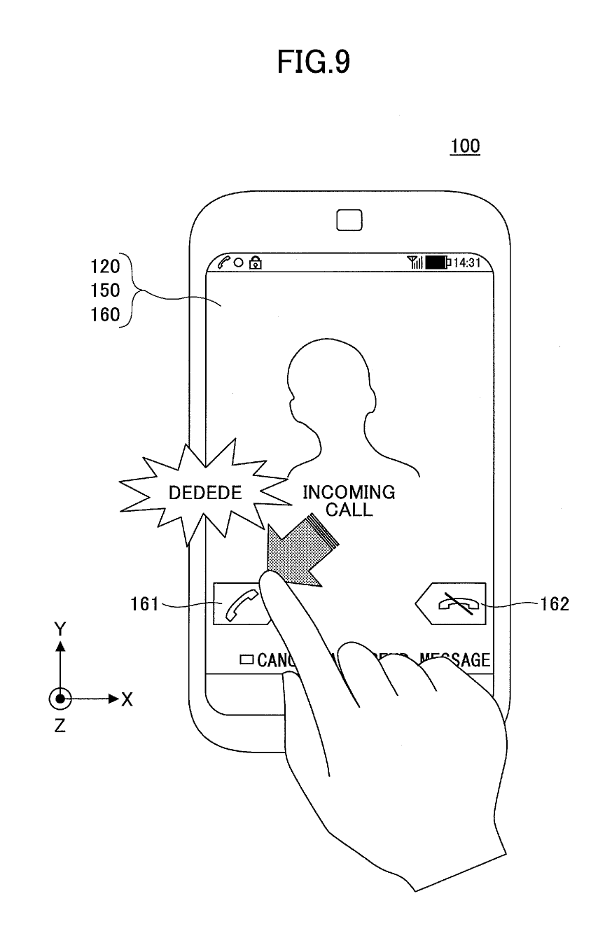

In the following, examples of the operating state of the electronic device 100 according to the embodiment are described with reference to FIGS. 9 to 14.

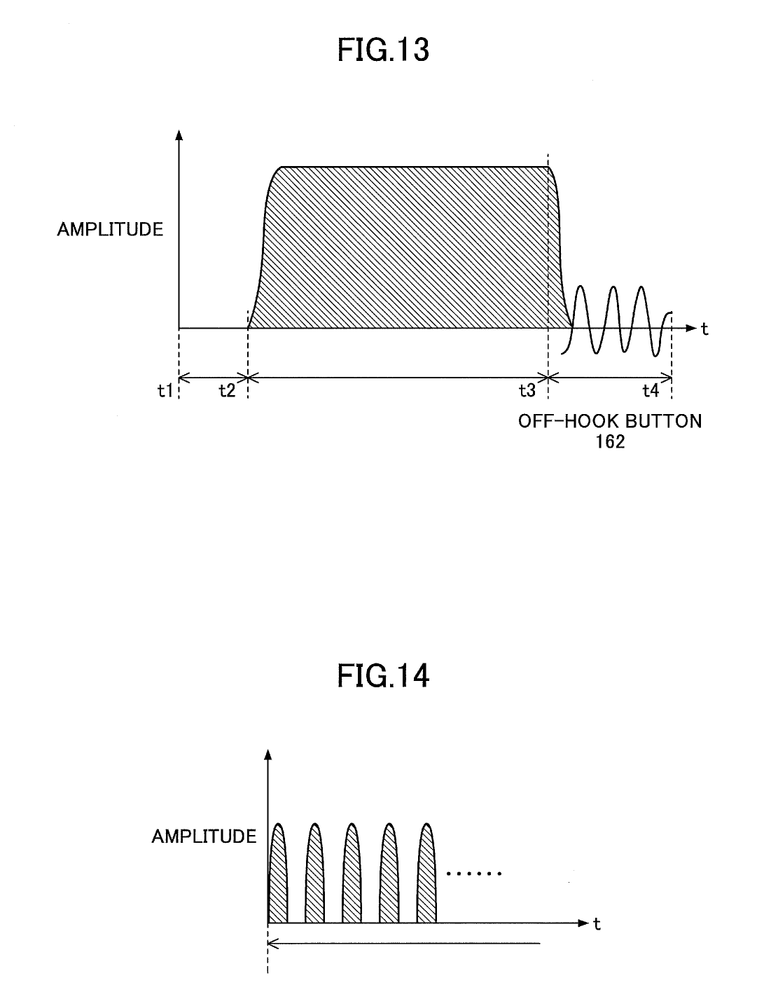

FIGS. 9 to 12 are diagrams illustrating the examples of the operating states of the electronic device 100 according to the embodiment. In FIGS. 9 to 12, XYZ coordinate systems similar to that described in FIGS. 2 and 4 are defined. FIGS. 13 and 14 are diagrams illustrating vibration patterns of the electronic device 100 according to the embodiment.

With reference to FIGS. 9 to 12, a case where the electronic device 100 is a smart phone, the smart phone is set in the manner mode, and the smart phone has an incoming call from the people of the non-group will be described. In FIGS. 9 to 12, the on-hook button 161 and the off-hook button 162 are illustrated as the GUI input parts. In the manner mode, the off-hook button 162 becomes the target GUI input part as illustrated in FIG. 7.

As illustrated in FIG. 9, in a case where the smart phone is set in the manner mode and has the incoming call from the people of non-group, if the user's fingertip travels toward the on-hook button 161 which is not the target GUI input part as illustrated by an arrow, the vibration in the ultrasound-frequency-band generated on the top panel 120 is switched off. Accordingly, the kinetic friction force applied to the user's fingertip is increased, and it becomes hard for the user to travel their fingertip toward the on-hook button 161 which is not the target GUI input part. In FIG. 9, an imitative sound “dedede” which represents the increased kinetic friction force applied to the fingertip is illustrated.

This operation corresponds to a flow in an order from START to END via S1: YES, S2: NO, S4 and S5:NO in the flowchart as illustrated in FIG. 8.

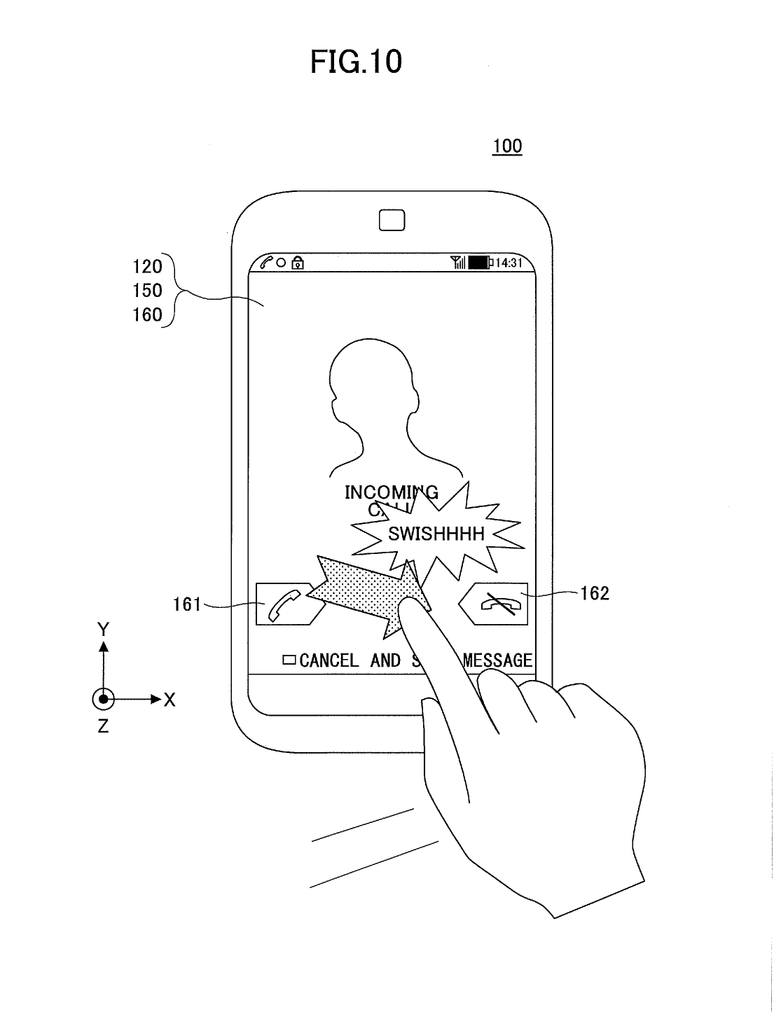

If the user travels their fingertip toward the off-hook button 162 which is the target GUI input part as illustrated in FIG. 10, the vibration in the ultrasound-frequency-band is generated on the top panel 120. Accordingly, it becomes easy for the user to travel their fingertip toward the off-hook button 162. The user's fingertip slips smoothly (swishhhh) toward the off-hook button 162 which is the target GUI input part and is guided to the off-hook button 162.

This operation corresponds to a flow in an order from START to END via S1: YES, S2: YES and S3 in the flowchart as illustrated in FIG. 8.

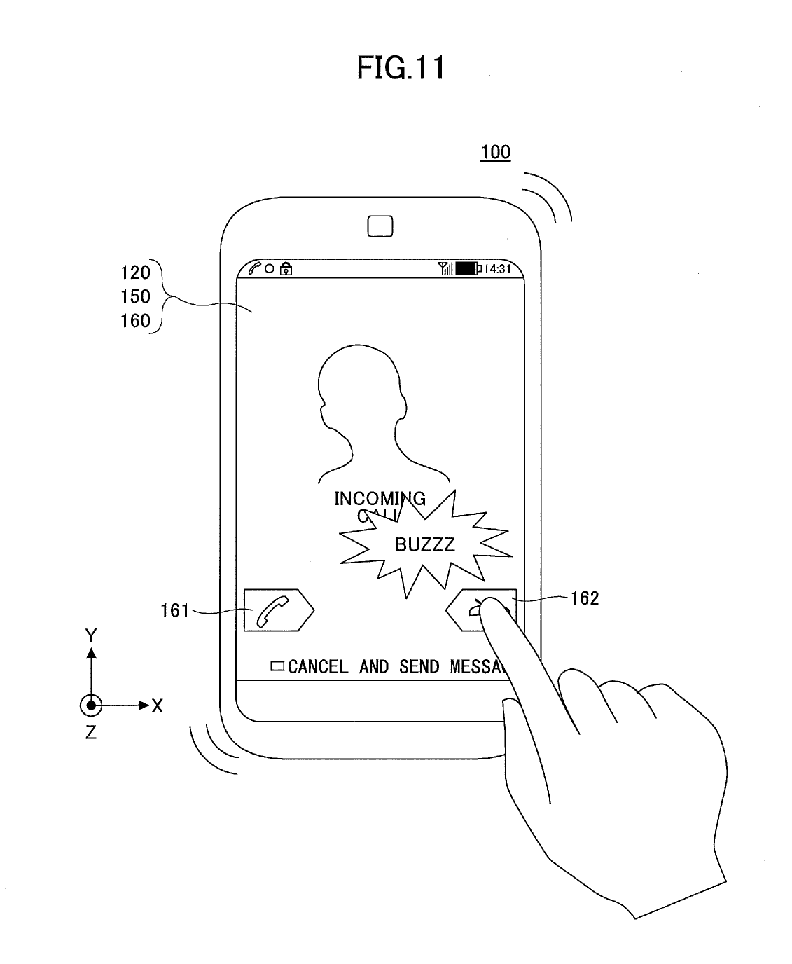

As illustrated in FIG. 11, when the user's fingertip reaches and stops at the off-hook button 162 which is the target GUI input part, the electronic device 100 generates the vibration in the audible range on the top panel 120 and informs the user that their fingertip reaches the off-hook button 162 through the tactile sensation. FIG. 11 illustrates an operating state in which the top panel 120 vibrates and rumbles “buzzz” in the audible range.

This operation corresponds to a flow in an order from START to END via S1: NO, S4, S5: YES and S6 in the flowchart as illustrated in FIG. 8.

When the user's fingertip reaches the off-hook button 162 and travels in the display area of the off-hook button 162 which is the target GUI input part, the electronic device 100 generates the vibration in the audible range on the top panel 120 and informs the user that their fingertip reaches the off-hook button 162 through the tactile sensation.

This operation corresponds to a flow in an order from START to END via S1: YES, S2: NO, S4, S5: YES and S6 in the flowchart as illustrated in FIG. 8.

According to the drive control apparatus 300 of the embodiment, it is possible to guide the user's fingertip to the target GUI input part by controlling the vibration in the ultrasound-frequency-band generated on the top panel 120 in response to the position of the manipulation input.

When the position of the manipulation input reaches the off-hook button 162 while the position is traveling as illustrated in FIG. 11, it may be necessary to get the fingertip off of the top panel 120 and press the off-hook button 162 again in order not to answer the incoming call by using the off-hook button 162. This depends on types of the OS.

In such a case, the electronic device 100 may use the pressure sensor 190 (see FIG. 3) and determine the user's manipulation when the user presses the top panel 120 based on detected signal of the pressure sensor 190.

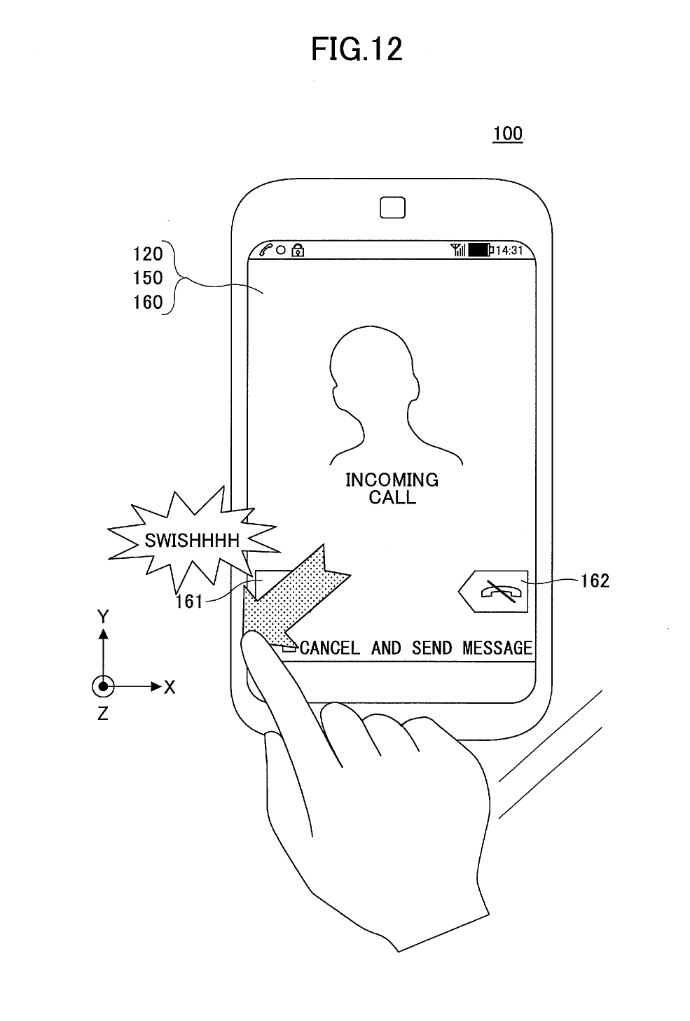

When the user travels their fingertip toward the on-hook button 161 from the position as illustrated in FIG. 9 and the fingertip reaches the on-hook button 161 as illustrated in FIG. 12, the electronic device 100 may generate the vibration in the ultrasound-frequency-band.

In this case, it is possible to make the user's fingertip slip smoothly (swishhhh) and pass over the on-hook button 161 without manipulating the on-hook button 161, since the kinetic friction force applied to the user's fingertip is reduced.

Such a control process may be realized by adding the display area of the on-hook button 161 which is not the target GUI input part to the control data and by causing the drive control apparatus 300 to perform the drive control so as to generate the vibration in the ultrasound-frequency-band on the top panel 120 when the position of the manipulation input is located in the on-hook button 161.

In the following, driving patterns of the vibrating element 140 and the LRA 180 of the electronic device 100 will be described with reference to FIGS. 13 and 14.

FIG. 13 is a diagram illustrating driving waveforms used for driving the vibrating element 140 and the LRA 180 of the electronic device 100. FIG. 14 is a diagram illustrating driving waveforms used for driving the vibrating element 140 of the electronic device 100. In FIG. 13, a horizontal axis indicates time and a vertical axis indicates amplitude of the drive signal which causes the vibrating element 140 or the LRA 180 to vibrate. In FIG. 14, a horizontal axis indicates time and a vertical axis indicates amplitude of the drive signal which causes the vibrating element 140 to vibrate. The off-hook button 162 is set as the target GUI input part.

As illustrated in FIG. 13, the manipulation input is performed at time t1 and the position of the manipulation input travels in a direction away from the off-hook button 162 which is the target GUI input part from time t1 to time t2. In this case, the amplitude of the drive signal output from the drive controller 240 is set to zero from time t1 to time t2. Accordingly, the vibrating element 140 is not driven and the vibration is not generated on the top panel 120.

At time t2, the traveling direction of the position of the manipulation input is changed in a direction approaching to the off-hook button 162. The position of the manipulation input travels in the approaching direction from time t2 to time t3. In this case, the amplitude of the drive signal output from the drive controller 240 is set to a designated value from time t2 to time t3. Accordingly, the vibrating element 140 is driven by the drive signal in the ultrasound-frequency-band and the vibration in the ultrasound-frequency-band is generated on the top panel 120.

As the position of the manipulation input reaches the off-hook button 162 at time t3, the amplitude of the drive signal output from the drive controller 240 becomes zero. Accordingly, the LRA driver 260 outputs the drive signal at the audible range frequency so as to drive the LRA 180, and the vibration at the audible range frequency is generated on the top panel 120.

Therefore, until the user's fingertip gets off of the top panel 120 at time t4, the LRA 180 is driven in accordance with the drive signal at the audible range frequency.

According to the operating states as described above, the user's fingertip is guided to the off-hook button 162 which is the target GUI input part, and the types of the vibration is switched when the user's fingertip reaches the off-hook button 162. Accordingly, the user can manipulate the off-hook button 162 only through the tactile sensation.

FIG. 13 illustrates the driving pattern in which the LRA 180 is driven by the drive signal at the audible range frequency when the position of the manipulation input reaches the off-hook button 162, and the vibration at the audible range frequency is generated on the top panel 120. However, the pattern of the vibration in the ultrasound-frequency-band may be changed as illustrated in FIG. 14 instead of generating the vibration at the audible range frequency.

FIG. 14 illustrates a driving pattern in which the vibrating element 140 is driven by the drive signal in the ultrasound-frequency-band intermittently at regular intervals. The vibration of the driving pattern as illustrated in FIG. 14 may be used instead of the vibration at the audible range frequency from time t3 to time t4 as illustrated in FIG. 13. It becomes possible to inform the user that the fingertip reaches the off-hook button 162 by the vibration at the ultrasound-frequency-band.

In this case, the electronic device 100 can have a configuration that does not include the LRA 180 and the LRA driver 260.

The electronic device 100 of the embodiment generates the natural vibration of the top panel 120 in the ultrasound-frequency-band in response to the position of the user's manipulation input and varies the kinetic friction force applied to the user's fingertip. Accordingly, it is possible to provide a fine or a crisp tactile sensation that makes the user recognize the direction in which the user should perform the manipulation input in an easy-to-understand manner.

Accordingly, it is possible to provide the drive control apparatus 300, the electronic device 100 and the method for drive control method that can provide the fine or crisp tactile sensation and make the user recognize the direction in which the user should perform the manipulation input in an easy-to-understand manner.

The electronic device 100 of the embodiment generates the drive signal by causing the amplitude modulator 320 to modulate only the amplitude of the sinusoidal wave at the ultrasound-frequency-band output from the sinusoidal wave generator 310. The frequency of the sinusoidal wave at the ultrasound-frequency-band generated by the sinusoidal wave generator 310 is equal to the natural vibration number of the top panel 120. The natural vibration number is determined in consideration of the weight of the vibrating element 140.

The drive signal is generated at the amplitude modulator 320 by modulating only the amplitude of the sinusoidal wave at the ultrasound-frequency-band generated by the sinusoidal wave generator 310 without modulating the frequency or the phase of the sinusoidal wave.

Accordingly, it becomes possible to generate the natural vibration of the top panel 120 at the ultrasound-frequency-band to the top panel 120 and to reduce the kinetic friction coefficient applied to the fingertip tracing the top panel 120 with absolute accuracy by utilizing the layer of air provided by the squeeze effect. It becomes possible to provide the fine or crispy tactile sensation as if the concavity or the convexity exists on the surface of the top panel 120 by utilizing the Sticky-band Illusion effect or the Fishbone Tactile Illusion effect to the user.

In the embodiment as described above, for the sake of providing the sense as if the concavity or the convexity exists on the top panel 120 to the user, the vibrating element 140 is being switched on or off. Turning off the vibrating element 140 is equal to setting the amplitude value represented by the drive signal used for driving the vibrating element 140 to zero.

However, it is not necessary to turn off the vibrating element 140 from a being turned on state. For example, the vibrating element 140 is driven based on the drive signal having a small amplitude instead of turning off the vibrating element 140. For example, the electronic device 100 may provide the sense as if the concavity or the convexity exists on the surface of the top panel 120 by reducing the amplitude to about one-fifth of that of the turned on state.

In this case, the vibrating element 140 is driven by the driving signal in a manner that the vibration of the vibrating element 140 is switched between a strong level and weak level. As a result, the strength of the natural vibration generated to the top panel 120 is switched between the strong level and the weak level. It becomes possible to provide the sense as if the concavity or the convexity exists on the surface of the top panel 120 through the user's fingertip.

If the electronic device 100 turns off the vibrating element 140 when making the vibration weaker in order to switch the vibration of the vibrating element 140 from the strong level to the weak level, the vibrating element 140 is switched off. Switching on and off the vibrating element 140 means turning on and off the vibrating element 140 intermittently.

According to the embodiments as described above, it becomes possible to provide the electronic device 100 and the drive control method that can provide a fine or crisp tactile sensation to a user.

According to the embodiments as described above, it becomes possible to provide a drive control apparatus, an electronic device and a drive control method that can make a user recognize a direction in which the user should perform the manipulation input in an easy-to-understand manner by providing a fine or crisp tactile sensation to a user.

So far, the preferred embodiments and modification of the semiconductor circuit apparatus and electronic apparatus are described. However, the invention is not limited to those specifically described embodiments and the modification thereof, and various modifications and alteration may be made within the scope of the inventions described in the claims.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiment of the present invention has been described in detail, it should be understood that various changes, substitutions, and alterations could be made hereto without departing from the spirit and scope of the invention.

What is claimed is:

1. A drive control apparatus that drives a first vibrating element of an electronic device including a display part, a top panel disposed on a display surface side of the display part and having a manipulation input surface, a position detector detecting a position of a manipulation input performed on the manipulation input surface and the first vibrating element generating a vibration in the manipulation input surface, comprising:
a first drive controller being configured to drive the first vibrating element by using a drive signal causing the first vibrating element to generate a natural vibration in an ultrasound-frequency-band in the manipulation input surface, the first drive controller being configured to drive the first vibrating element so as to switch the natural vibration between a strong level and a weak level in accordance with a relationship between a position of a designated GUI input part displayed on the display part and a position of a manipulation input performed onto the manipulation input surface.

2. The drive control apparatus as claimed in claim 1, wherein the first drive controller drives the first vibrating element so as to guide the user's fingertip by switching the natural vibration between the strong level and the weak level.

3. The drive control apparatus as claimed in claim 1, wherein the driving signal causes the first vibrating element to generate the natural vibration in the ultrasound-frequency-band in the manipulation input surface, the natural vibration having a constant frequency and a constant phase.

4. The drive control apparatus as claimed in claim 1, wherein the first drive controller drives the first vibrating element in response to a first driving pattern before the position of the manipulation input performed onto the manipulation input surface enters into a display area of the designated GUI input part displayed on the display part, and drives the first vibrating element in response to a second driving pattern when the position of the manipulation input enters into the display area of the designated GUI input part.

5. The drive control apparatus as claimed in claim 1, further comprising:
a second drive controller;
wherein the electronic device further includes a second vibrating element generating a vibration at audible range frequency in the manipulation input surface, and
wherein the second drive controller drives the second vibrating element when the position of the manipulation input enters into the display area of the designated GUI input part.

6. The drive control apparatus as claimed in claim 1, wherein the manipulation input surface has a rectangular shape having long sides and short sides in plan view, and
wherein the first drive controller causes the first vibrating element to vibrate so that a standing wave of which amplitude varies along the long side occurs on the manipulation input surface.

7. The drive control apparatus as claimed in claim 1, wherein the first drive controller drives the first vibrating element intermittently so as to switch the natural vibration between the strong level and the weak level.

8. An electronic device comprising:
a display part;
a top panel disposed on a display surface side of the display part and having a manipulation input surface;
a position detector detecting a position of a manipulation input performed on the manipulation input surface; a vibrating element generating a vibration in the manipulation input surface; and
a drive controller being configured to drive the vibrating element by using a drive signal causing the vibrating element to generate a natural vibration in an ultrasound-frequency-band in the manipulation input surface, the drive controller being configured to drive the vibrating element so as to switch the natural vibration between a strong level and a weak level in accordance with a relationship between a position of a designated GUI input part displayed on the display part and a position of a manipulation input performed onto the manipulation input surface.

9. The electronic device as claimed in claim 8, further comprising:
a memory configured to store control data in which a first identification data identifying the designated GUI input part and a second identification data identifying a designated operation mode in which the designated GUI input part is displayed on the display part;
wherein the designated GUI input part is included in the control data as a GUI input part used by the user in the designated operation mode, and
wherein the drive controller drives the vibrating element so as to guide the user's fingertip by switching the natural vibration between the strong level and the weak level.

10. The electronic device as claimed in claim 8, further comprising:
a pressure sensor configured to detect a pressing force applied onto the manipulation input surface by the manipulation input.

11. A drive control method for driving a vibrating element of an electronic device including a display part, a top panel disposed on a display surface side of the display part and having a manipulation input surface, a position detector detecting a position of a manipulation input performed on the manipulation input surface and the vibrating element generating a vibration in a manipulation input surface, comprising:
driving, by a computer, the vibrating element by using a drive signal causing the vibrating element to generate a natural vibration in an ultrasound-frequency-band in the manipulation input surface, the driving being configured to drive the vibrating element so as to switch the natural vibration between a strong level and a weak level in accordance with a relationship between a position of a designated GUI input part displayed on the display part and a position of a manipulation input performed onto the manipulation input surface.
